(19) United States
(12) Patent Application Publication
(10) Pub. No.: US 2005/0213965 A1
(43) Pub. Date: Sep. 29, 2005

(54) Communications testing apparatus and method of use

(76) Inventors: Ernest Eisenhardt Bergmann, Bethlehem, PA (US); William Joseph Thompson, Kempton, PA (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/808,254

(22) Filed: Mar. 24, 2004

(51) Int. Cl. H04B 10/08

(52) U.S. Cl. 398/16

(57) ABSTRACT

A tester for testing components of a communication system, such as an optical communication system is disclosed. The tester may utilize a testing method to test a communication component (e.g. a cable or repeater) by stressing a test signal. The tester may utilize external transmitters and external receivers in order to implement the test in a similar communication environment as the tested communication components normally operate.

### CROSS-REFERENCE TO RELATED APPLICATIONS

The present application claims priority under 35 U.S.C. § 119(e) from provisional patent application Ser. No. (Attorney Docket Number Circ.014), filed on Mar. 10, 2004, and entitled “Apparatus and Method to Test Digital Communications”. The disclosure of this application is specifically incorporated herein by reference.

### BACKGROUND

Communication systems play a major role in everyday life. Examples of communication systems are telephone systems, broadcast television systems, cellular telephone systems, local area networks (LAN) and wide area networks (WAN) and dial-up and broadband communications, such as the internet.

Although a user may only see the communication interface (e.g. a telephone, a television, a cellular phone, or a computer), there are many behind-the-scenes devices that facilitate the communication in a communication system. For example, in a telephone communication system, there may be thousands of miles of communication cable between two telephones that are communicating with each other. In addition to the thousands of miles of communication cable, there are also other devices that are necessary for these two remotely located telephones to communicate. Examples of these communication devices are telephone switches and repeaters. In fact, between any two telephones communicating with each other, there may be hundreds or thousands of components that interoperate with each other, at a very high accuracy, in order to facilitate the communication.

As can be readily appreciated, if one of these components is not working properly, communication may fail. If communication fails, because of the components in the communication system is not operating properly, then that component must be located so it can be replaced or repaired. However, because there are so many components in a communication system, it is often difficult to determine which component is broken and is in need of repair.

### SUMMARY

In accordance with an example embodiment, an apparatus includes a first output port configured to output a first reference test signal, and a first input port configured to input a second reference test signal. The apparatus also includes a second output port configured to output a first stressed test signal, wherein the second reference test signal is based on the first reference test signal and the first stressed test signal is based on the second reference test signal.

In accordance with another example embodiment, a method includes outputting a first reference test signal from a first output port of a communication testing device and inputting a second reference test signal into a first input port of the communication testing device. The method also includes outputting a first stressed test signal from a second output port of the communication testing device.

### BRIEF DESCRIPTION OF THE DRAWINGS

The invention is best understood from the following detailed description when read with the accompanying drawing figures.

FIG. 1 is a schematic diagram of a telephone communication system in accordance with an example embodiment.

FIGS. 2 and 3 are schematic diagrams of testing apparati according to an example embodiment.

FIGS. 4 and 5 are schematic diagrams of testing apparati utilizing stressing mediums to test components of the communication system in accordance with an example embodiment.

FIGS. 6, 7, and 8 are schematic diagrams of testing apparati utilizing external transmitters and external receivers to test components of a communication system in accordance with an example embodiment.

FIGS. 9 and 10 are schematic diagrams of testing apparati without external transmitters or receivers to test components of a communication system in accordance with an example embodiment.

FIGS. 11, 12, 13, 14, 15, and 16 are schematic diagrams of testing apparati utilizing a switch to optionally utilize external transmitters and/or external receivers to test components of a communication system in accordance with an example embodiment.

### DETAILED DESCRIPTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known apparati and methods may be omitted so as to not obscure the description of the present invention. Such methods and apparati and methods are clearly within the contemplation of the inventors in carrying out the example embodiments. Wherever possible, like numerals refer to like features throughout.

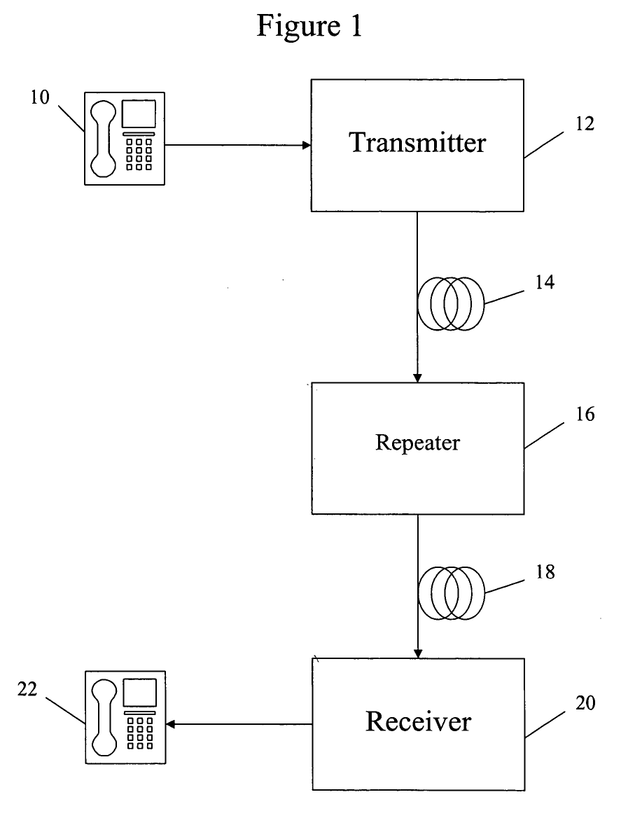

The simplified communication system of the example embodiment of FIG. 1 may be implemented in many different ways. For instance, the transmitter 12 may be a laser and receiver 20 may be an optical detector. When a communication system is designed, the wavelength of a laser, as transmitter 12, may be picked from several different types of lasers that output light at different wavelengths. When a transmitter, including a laser that inputs a given wavelength, is chosen, a repeater must also be appropriately chosen to be compatible with this wavelength.

As will become clearer as the present description continues, example embodiments relate to an apparatus including a first output port, a first input port, and a second output port. The first output port is configured to output a first reference test signal. The input port is configured to input a second reference test signal. The second output port is configured to output a first stressed test signal. The apparatus may be connected to components of a communication system in order to test the communication system. In embodiments, the apparatus includes an internal transmitter which generates the first reference test signal. The first reference test signal may be output from the first output port to drive an external transmitter. The external transmitter may be under test or may have certain characteristics that are necessary for particular test. The output of the external transmitter may be the second reference test signal, which is based on the first reference test signal and is input into the apparatus at the first input port. The second reference test signal may be passed through its stressing medium to generate the first stressed test signal.

As further described in connection with example embodiments, a testing apparatus, a stressing medium may be necessary in order to artificially create harsh communication conditions for the purposes of conducting a test. Because many communication systems operate so effectively and efficiently, it is difficult to detect errors. For instance, a communication system which is malfunctioning may only create an error once every thirty hours under normal conditions. Although the communications system may only generate one error every thirty hours, this error may be significant and need to be detected. However, for practical reasons, a test lasting thirty hours to detect a single error may not be possible. Accordingly, the stressing medium creates harsh conditions in order to artificially increase the probability of error. In increasing the probability of error, a malfunctioning communication system component may be detected in a significantly shorter period of time, making the test practical.

Testing using the external transmitter may be very important. There are many types of communication systems, which use different types of transmitters and receivers. For example, in optical communication systems (e.g. fiber-optic), different systems may transmit light signals at different wavelengths. Each wavelength may be generated by a different type of laser. It may not be practical for every type of laser to be included in a testing apparatus. However, it is desirable for communication systems to be adaptable to use an external laser specific to the tested communication system. The output of the external laser can be passed through a stressing medium. The outputting stressing medium may be first stressed test signal, which is passed through the tested communication system. Accordingly, by utilizing an external transmitter, increased flexibility in a testing apparatus may be implemented to test many different communication systems.

The flexibility of a testing apparatus to test many different communication systems is significant. These testing apparatuses may be fairly expensive. Accordingly, a different testing apparatus for every type of communication system may not be economically feasible. Accordingly, a testing apparatus that has increased flexibility can make testing and fixing a malfunctioning communication system more economical. By reducing the cost of detecting and fixing a communication system, the cost of communication services (e.g. telephone services, television broadcast services, or cellular services) can be lowered and become more affordable for everyday consumers.

It is noted that in telecommunications and data communications, communications segments or links are normally tested. In other words, communication is successful in a link when the transmitter, transmission medium, and receiver are all successful operating in concert to transfer information from the transmitter to the receiver. Successful transmission will often produce negligible error rates unless some amount of stress is applied. The amount of stress that is needed to produce a readily discernable error rate is a measure of the “margin” that that link has. Operating with insufficient margin is usually undesirable because any fluctuation in the environment or in component aging may very well result in unacceptable performance. Conversely, having adequate margin is the way to have a robust communications system. Many times a transmission system will consist of multiple segments or links and it is desired to have the capability to measure the margin of each such link individually. Having the chance to introduce controlled stress in communications links that are controlled by the test CPU enables the test of each link. Such aspects are described in connection with various and sundry example embodiments herein.

FIG. 1 is a schematic diagram of a telephone communication system which may be tested by apparati and methods of example embodiments. In this example, the transmission of a communication signal (i.e. an audio voice signal) is from a telephone 10 to a telephone 22 is shown. Illustratively, telephone 10 is coupled to a transmitter 12 and a telephone 22 is coupled to receiver 20. One of ordinary skill in the art will appreciate that there may be several communication devices connected between the telephone 10 and the transmitter 12 as well as between the telephone 22 and the receiver 20 to facilitate communication. However, these communication devices have been omitted so as to not obscure the descriptions of example embodiments.

The transmitter 12 transmits or outputs a communication signal from the telephone 10 through the cable 14. Cable 14 may be optical fiber, a metal conducting layer, or another communication medium. One of ordinary skill in the art will recognize that cable 14 represents a communication medium which may be substituted with alternative mediums, such as a radio wave media and waveguide free optical media.

The signal transmitted by transmitter 12 may travel over a great distance to the receiver 20 and the telephone 22. As the signal is transmitted over a long distance, the signal may be attenuated. Accordingly, a repeater 16 may be used to boost up the strength of the signal so that it will reach the receiver 20 in the telephone 22. The repeater 16 may receive a signal from cable 14 and regenerate the signal through amplification and noise reduction techniques well-known in the various communication arts. Thereafter the strengthened signal is output to cable 18.

The signal may be transmitted through cable 18 to receiver 20, where it is in turn communicated to telephone 22. One of ordinary skill in the art will recognize that more than one repeater may be necessary between a transmitter and receiver; and that a communication system may utilize several different transmitters at different levels in conjunction with several different receivers. In optical communication systems, a repeater may be an optical amplifier.

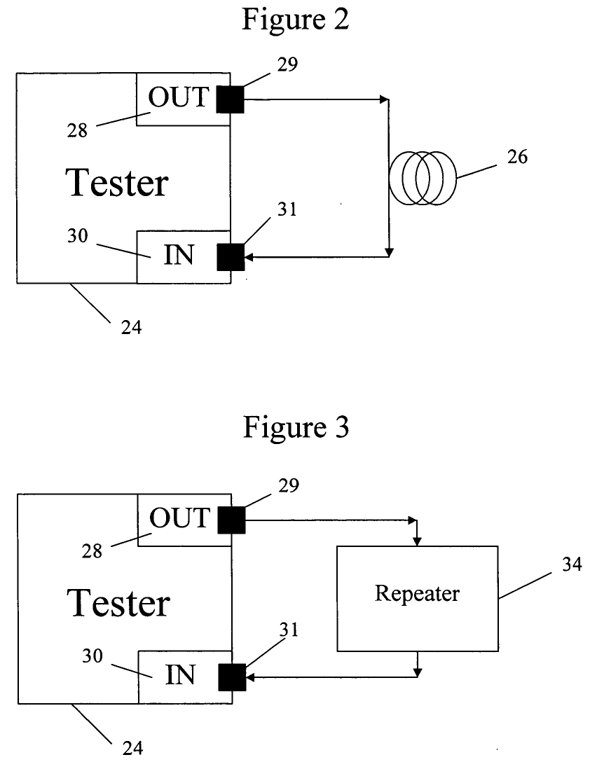

FIGS. 2 and 3 are schematic diagrams of testing apparati of example embodiments. In FIG. 2, a testing apparatus (tester) 24 is testing a cable 26. An OUT section 28 of the tester 24 outputs a signal at an output port 29 into a cable 26. The signal is transmitted through cable 26 and is input into an IN section 30 through an input port 31. The signal may be carefully chosen to be output from OUT section 28. This signal input into the cable 26 may be a predetermined signal with varying characteristics. The tester 24 may monitor the signal that is input into input section 30. Alternatively, or additionally, tester 24 may monitor the signal being output from output section 28. This monitoring may be used to determine the performance of cable 26. For instance, tester 24 may output a signal at varying data rates. The signal input into input section 30 may be monitored to determine the magnitude of the data rate(s) transmitted through cable 26. Likewise, as illustrated in exemplary FIG. 3, a repeater 34 may be tested by tester 24.

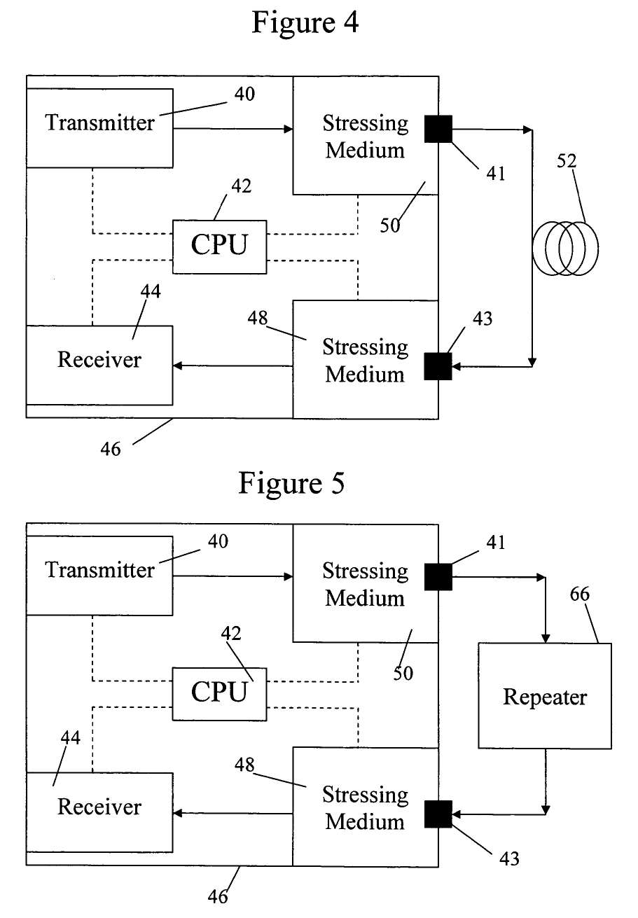

FIGS. 4 and 5 are schematic diagrams of a testing apparatus (tester) 46 in accordance with example embodiments. As shown in FIG. 4, tester 46 tests a cable 52, while in FIG. 5 tester 46 tests a repeater 66. Tester 46 illustratively includes internal transmitter 40, stressing medium 50, output port 41, input port 43, stressing medium 48, and internal receiver 44. It is noted that CPU 42 may control these components in order to perform a test. Specifically, CPU 42 may control internal transmitter 40 to output a signal (e.g. an optical signal) that is specific to a given test. The signal output from transmitter 40 may be input into stressing medium 50, where the signal is stressed. It is noted that the CPU 42 may be implemented in hardware, or software, or both. As the function of the hardware and/or software will be readily apparent to one of ordinary skill in the art to which the present example embodiments pertains, and a variety of hardware and software configurations will also b e readily apparent to the ordinarily skilled in the art, many details of these hardware and software implementations are not described in detail so as to avoid obscuring the description of the example embodiments. Of course, these hardware and/or software implementations are within the scope of the appended claims.

The signal may be stressed through attenuation, dispersion, or interference. Attenuation results in a reduction in the amplitude/strength of the signal. Dispersion results in the signal's not being sharp; making its detection by a receiver more difficult. Interference is the influence of other signals in a communication medium, which degrade the performance of a communication system. Of course these deleterious effects are merely illustrative, and there are other mechanisms for stressing a signal for testing purposes.

The purpose of stressing a signal is to emulate harsh communication conditions to test the limits of a communication system. A stressing medium(s) may be controlled by CPU 42 to change stresses on a signal. For example, the levels and combinations of attenuation, dispersion, interference and other phenomena may be varied in a calculated manner to test the limits of a communication system.

CPU 42 may follow a specific method in order to facilitate a test. This method may include a variation of performance of a transmitter and/or the stressing mediums. The signal at the stressing medium may also be monitored. The data from such monitoring may be received by the CPU 42 as feedback so that it can be realized exactly what signal is transmitted into and/or out of cable 52 or repeater 66.

The signal output from cable 52 or repeater 66 may be input through input port 43 into another stressing medium 48. In certain example embodiments, a stressing medium may be utilized at a receiving side to emulate other than desired (poor) communication conditions. The attributes of the stressing medium may be controlled by CPU 42. The signal may then be output from stressing medium 48 and input into receiver 44. The output of the receiver 44 may be communicated to CPU 42 so that analysis of the communication capabilities of cable 52 or repeater 66 can be determined.

The analysis of a tested cable 52 or test repeater 66 may be conducted by comparing the actual performance to the expected performance of a functioning communication component. For example, a functioning communication component may have a specific bit error rate (BER) characteristic. As is well-known, the BER is the number of bits per unit time that are erroneously communicated divided by the bits that are correctly communicated. An illustrative BER for a communication component may be 10⁻¹⁵. Accordingly, if the data rate of a communication system is 10 Gb/s, it may take over 30 hours to transmit 10¹⁵ bits. In other words, it may take more than 30 hours to see an erroneous transmission. However, in a tester according to example embodiments of FIGS. 4 or 5, by stressing a communication signal, this bit error rate may be reduced to a more detectable level, such as 10⁻⁵. Thus, by increasing the bit error rate by introducing stress in a communication signal, a test of a communication component can be effected in a more reasonable time period, such as several minutes. Accordingly, based on expected results of functioning communication equipment under stressed conditions, the effective bit error rate can be interrelated from a tested bit error rate.

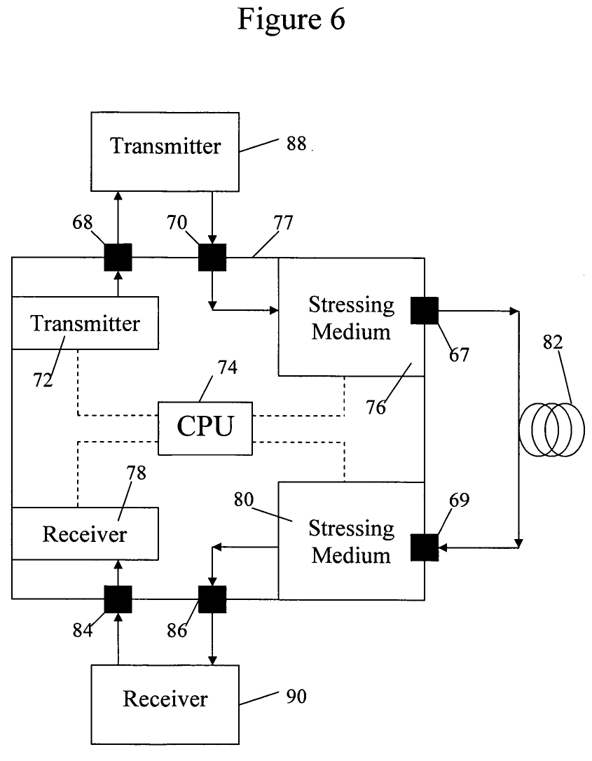

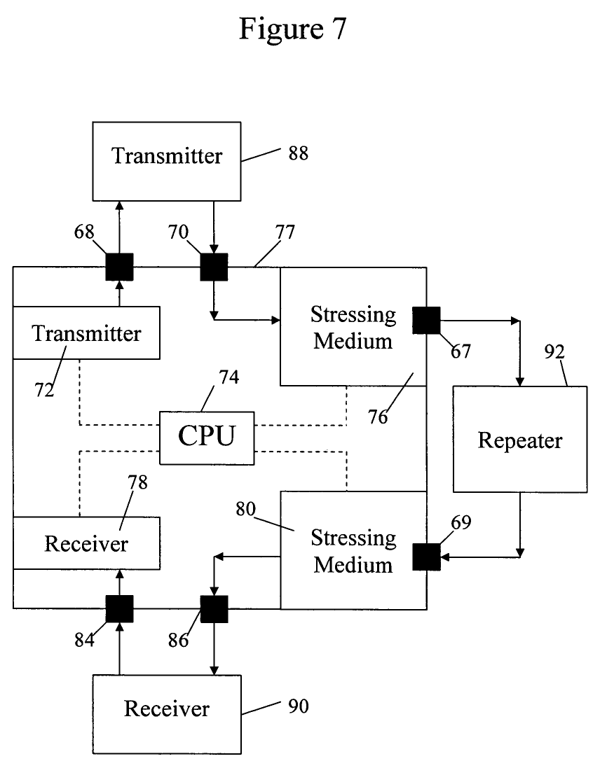

It is noted that in certain circumstances, it may be beneficial to include components of communications system or link that are external to the testing apparatus. In the example embodiments of FIGS. 6, 7, and 8 a tester 77, include an external transmitter 88 or an external receiver 90, or both to test either cable 82 or repeater 92. In these figures, internal transmitter 72 is controlled by CPU 74 to output a test signal. The test signal is output through output port 68, which interfaces with external transmitter 88. The signal output from internal transmitter 72 may drive the signal output from external transmitter 88. One of ordinary skill in the art will appreciate that transmitter 88 may be configured to be driven by transmitter 72, which outputs an optical signal at a different wavelength(s). Alternatively, other components may be used to allow an internal transmitter 72 to drive an external transmitter 88. The transmitter 88 may be under test or may be used as a reference for testing cable 82 or repeater 92.

The output of external transmitter 88 may be input into the tester 77 at input port 70. This signal from external transmitter 88 may be input into stressing medium 76. Stressing medium 76 may be controlled by CPU 74, according to an illustrative testing method of an example embodiment. The stress test signal may then be output through output port 67 into a tested cable 82 or a tested repeater 92. One of ordinary skill in the art will appreciate that the cable 82 or the repeater 92 may be functioning communication components used to test the interaction of the external transmitter 88 and 82 or 92. Also, one of ordinary skill in the art would appreciate that the components of a communication system that may be tested are not limited to the cable 82 or the repeater 92. In some embodiments, cable 82 includes optical fiber and repeater 92 includes an optical amplifier.

The signal output from either cable 82 or repeater 92 may then be input into a tester 77 through input port 69. The signal output from cable 82 or repeater 92 may be stressed in stressing medium 80, under the control of CPU 74. Whether the signal output from cable 82 or repeater 92 is stressed, is based on a testing method performed by CPU 74.

The output of stressing medium 80 may then be output from the tester 77 through output port 86 into an external receiver 90. The external receiver 90 may be compatible with transmitter 88. For example, if external transmitter 88 communicates at a given wavelength, then receiver 90 can have a particular sensitivity at that given wavelength. The output of the receiver 90 may be input into the tester 77 through input port 84 and received at the internal receiver 78. In certain example embodiments, the external receiver 90 may be under-test. For instance, the sensitivity of receiver 90 may be tested. T he situations where external transmitter 88 and/or external receiver 90 are under-test, external transmitter 88 and internal transmitter 72 may have similar characteristics, and external receiver 90 and internal receiver 78 may also have these similar characteristics.

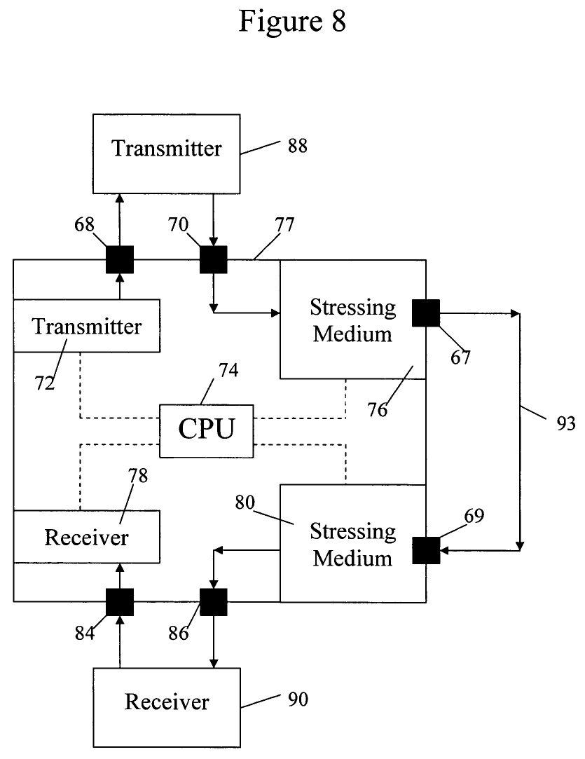

FIG. 8 is a schematic diagram of an example embodiment in which the transmitter 88 and the receiver 90 are under-test. To wit, output port 67 and input port 69 are connected through a connection 93 so that the signal output from output port 67 is essentially the same as to the signal input into input port 69. One of ordinary skill in the art will appreciate that the external transmitter 88 may be tested in an isolated environment, by the output port's (86) being connected to the output port 84. Likewise, external receiver could be tested in a similar manner by connecting output port 86 68 to input port 8470.

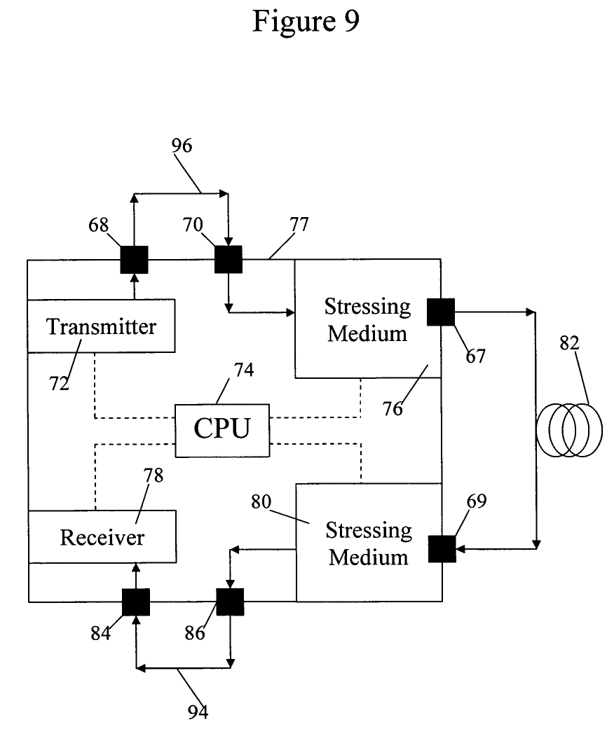

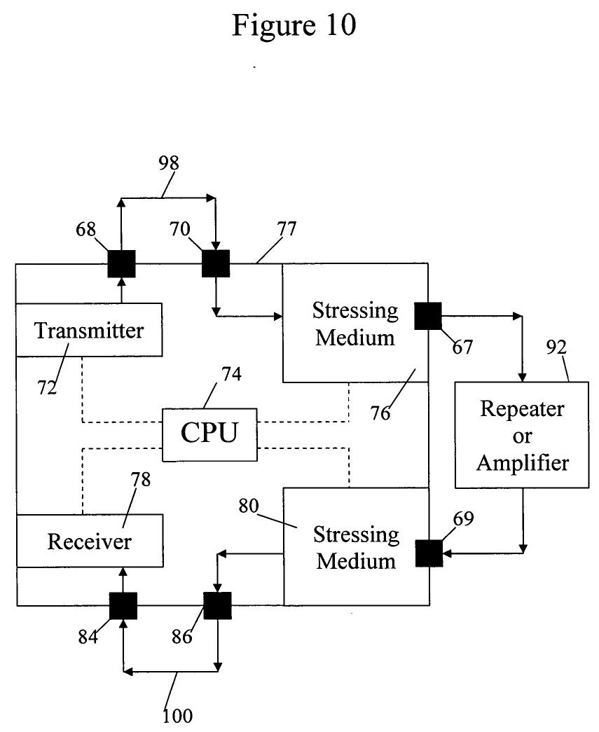

In accordance with example embodiments and as described in connection with FIGS. 9 and 10, the testing apparati may be modified so external transmitters and external receivers are not used. This may be accomplished by connecting output port 68 and input port 70 by the connector connection 96 and output port 86 and input port 84 by the connection 94. In the example embodiments illustrated in FIGS. 9 and 10, tester 77 can operate similar to tester 46 illustrated in exemplary FIGS. 4 and 5. However, the illustrative testing apparatus 77 has the advantage of flexibility; for example an external transmitter and/or external receiver can be connected and utilized.

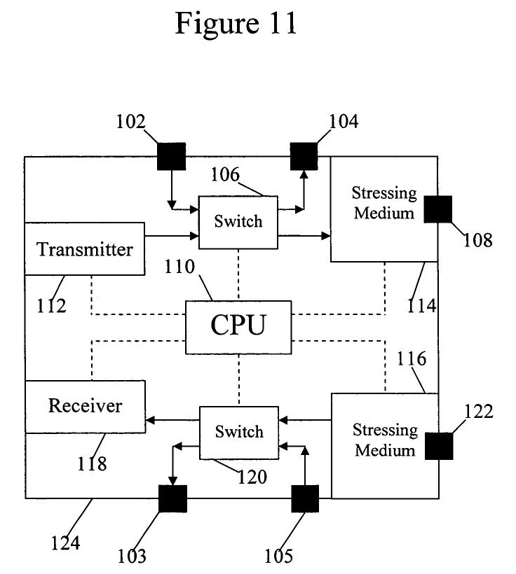

FIGS. 11-16 are schematic diagrams of example embodiments in which a tester 124 includes a switch 106 and a switch 120. The tester 124 also includes an internal transmitter 112, a stressing medium 114, a stressing medium 116, and an internal receiver 118. In the illustrative embodiments presently described the switch 106 comprises two inputs. One input is from internal transmitter 112, while a second input is from input port 102. Likewise, switch 106 has two outputs.

The first output is to stressing medium 114 and the second output is to output port 104. Stressing medium 114 may be connected to output port 108 and stressing medium 116 may be connected to input port 122. Switch 120 may have two inputs. A first input is from stressing medium 116 and a second input is from input port 105. Likewise, switch 120 may have two outputs. A first output may be connected to output port 103, while a second output may be connected to internal receiver 118. External Internal transmitter 112, switch 106, stressing medium 114, stressing medium 116, switch 120, and receiver 118 may be controlled by CPU 110 in order to implement a testing method.

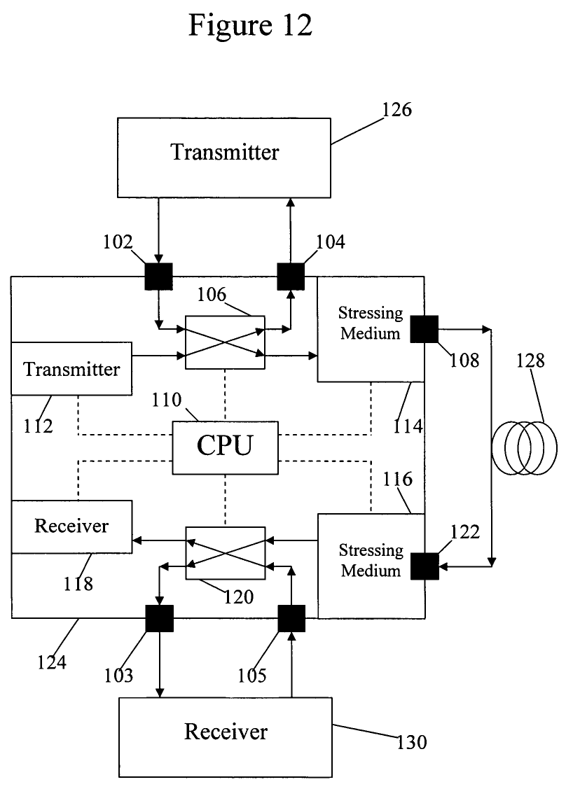

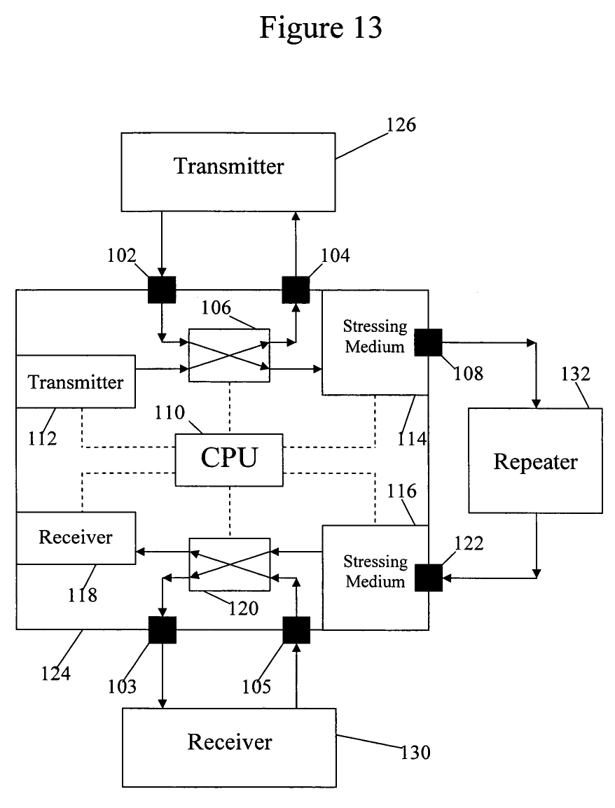

FIGS. 12-16 also illustrate how switch 106 and switch 120 are utilized to test communication system components in example embodiments. In FIGS. 12 and 13, switch 106 is used so that external transmitter 126 is driven by internal transmitter 112. Accordingly, the output of external transmitter 126 is coupled to stressing medium 114 through switch 106. The signal output from stressing medium 114 is transmitted through either cable 128 or repeater 132. Likewise, the output of stressing medium 116 is coupled to external receiver 130 through switch 120. The output of receiver 130 is coupled to internal receiver 118 through switch 120.

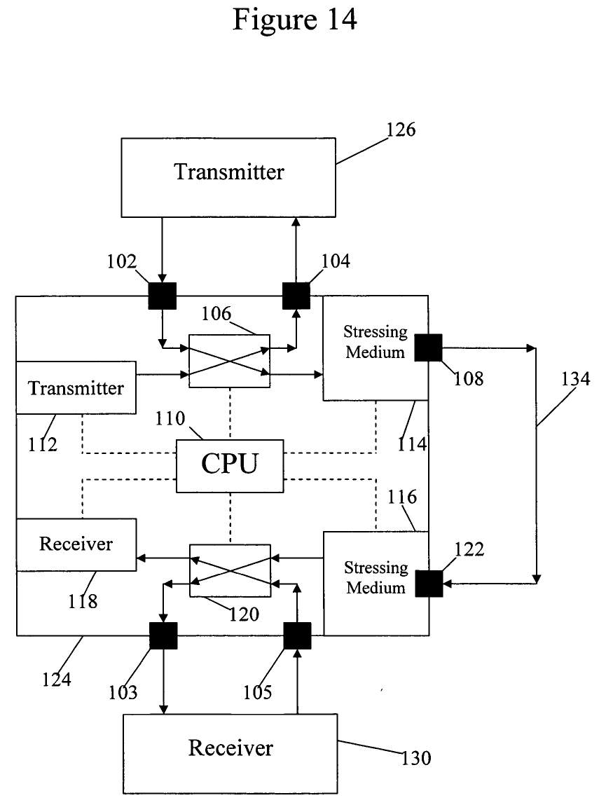

FIG. 14 illustrates an embodiment where the transmitter 126 and/or the receiver 130 are under-test. In this circumstance, output port 108 is connected through connector connection 134 to input port 122. Accordingly, the signal output from output port 108 is essentially the same as signal input into input port 122. In this circumstance, external transmitter 126 and/or external receiver 130 can be isolated, so that it can be tested according to a testing method.

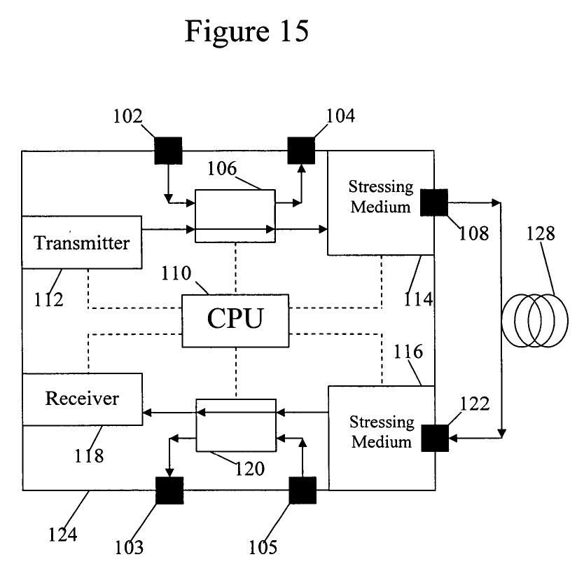

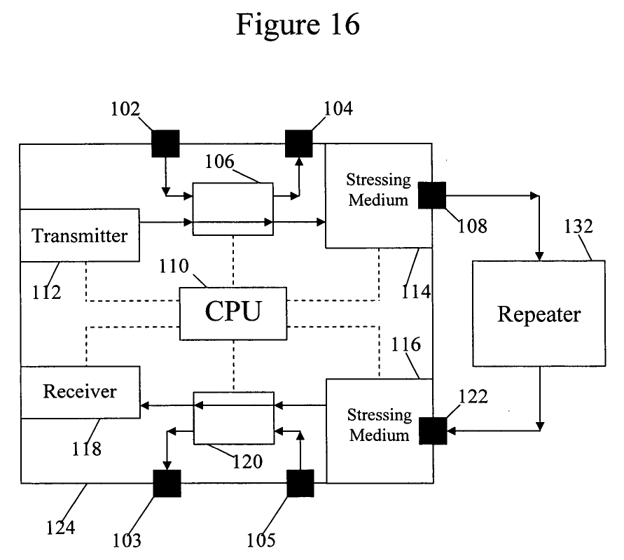

FIGS. 15 and 16 illustrate tester 124 in accordance with an example embodiment wherein either the cable 128 or repeater 132 are tested without utilizing external receivers or external transmitters. In such a circumstance, transmitter 112 is coupled to stressing medium 114 through switch 106. Likewise, stressing medium 116 is coupled to receiver 118 through switch 120. In circumstances illustrated in exemplary FIGS. 15 and 16, tester 124 operates similar to tester 46. However, the tester 124 has increased flexibility over tester 46, as external transmitters and receivers may be utilized.

In the example embodiments of FIGS. 10-16, utilizing switches 106 and 120, which are controlled by CPU 110, a testing method can switch in and out external transmitters and/or external receivers. By being able to switch externals transmitters in or out of the testing method tester 124 may be able to test more than one optical component at a time. Additionally, by being able to switch in and out external transmitters and/or external receivers, the testing methods may be used to isolate tested communication components, so that a malfunctioning testing component can be easily identified.

In view of this disclosure it is noted that the various methods and devices described herein can be implemented in either software or hardware or a combination of the two to effect the testing of communications systems and components. Further, the various methods and parameters are included by way of example only and not in any limiting sense. Therefore, the embodiments described are illustrative and are useful in testing communications systems and components, and are not intended to be limitive to the example embodiments. In view of this disclosure, those skilled in the art can implement the various example apparati and methods in testing communications equipment and systems, while remaining within the scope of the appended claims.

1. An apparatus comprising:
a first output port configured to output a first reference test signal;
a first input port configured to input a second reference test signal; and
a second output port configured to output a first stressed test signal, wherein the second reference test signal is based on the first reference test signal and the first stressed test signal is based on the second reference test signal.

2. The apparatus of claim 1, wherein at least one of the first reference test signal, the second reference test signal, and the first stressed test signal is an optical signal.

3. The apparatus of claim 1, wherein at least one of the first output port, the first input port, and the second output port is a fiber optic port.

4. The apparatus of claim 1, wherein the first reference test signal is modulated at an external transmitter to output the second reference test signal from the external transmitter.

5. The apparatus of claim 12, wherein:
the first reference test signal and the second reference test signal are modulated at different frequencies; and
the first reference test signal and the second reference test signal carry the same data.

6. The apparatus of claim 1 wherein the first reference test signal and the second reference test signal are modulated at the same wavelength; and
the first reference test signal and the second reference test signal carry substantially the same data.

7. The apparatus of claim 4, comprising an internal transmitter, wherein the first reference test signal is generated at the internal transmitter.

8. The apparatus of claim 1, comprising stressing medium, wherein the second reference test signal is stressed at the stressing medium to output the first stressed test signal from the stressing medium.

9. The apparatus of claim 8, wherein the stressing medium stresses the second reference test signal by at least one of:
attenuating the second reference test signal;
creating dispersion in the second reference test signal; and
creating interference with the second reference test signal.

10. The apparatus of claim 1, wherein the apparatus monitors at least one of the first reference test signal, the second reference test signal, and the first stressed test signal.

11. The apparatus of claim 1, wherein:
the apparatus comprises a first switch, an internal transmitter, and a stressing medium:
the internal transmitter is coupled to the first output port through the first switch, when the first switch is in a first switching state; and
the internal transmitter is coupled to the stressing medium through the first switch when the first switch is in a second switching state.

12. The apparatus of claim 11, wherein the first input port is coupled to the stressing medium when the first switch is in the first switching state.

13. The apparatus of claim 1, comprising:
a second input port configured to input a second stressed test signal;
a third output port configured to output a third stressed test signal; and
a third input port configured to input a fourth stressed test signal.

14. The apparatus of claim 13, wherein the third stressed test signal and the fourth stressed test signal are the same.

15. The apparatus of claim 13, wherein the apparatus monitors at least one of the first reference test signal, the second reference test signal, the first stressed test signal, the second stressed test signal, the third stressed test signal, and the fourth stressed test signal.

16. The apparatus of claim 13, wherein the second output port is externally coupled to the second input port.

17. The apparatus of claim 16, wherein the second output port is externally coupled to the second input port by a communication link under test.

18. The apparatus of claim 17, wherein the communication link under test comprises at least one of:
a communication medium; and
a communication device.

19. The apparatus of claim 18, wherein the communication medium is chosen from the group consisting essentially of:
optical media;
wire line media; and
wireless media.

20. The apparatus of claim 18, wherein the communication device is at least one of:
an amplifier;
a repeater;
a coupler; and
a polarizer.

21. The apparatus of claim 13, wherein the third output port is externally coupled to the third input port.

22. The apparatus of claim 21, wherein the third output port is coupled to an external device under test.

23. The apparatus of claim 22, wherein the external device under test is an external receiver.

24. The apparatus of claim 22, wherein the external device under test inputs the third stressed test signal and outputs the fourth stressed test signal.

25. The apparatus of claim 1, wherein the apparatus includes an internal receiver.

26. The apparatus of claim 13, wherein the apparatus comprises an internal receiver.

27. The apparatus of claim 26, wherein the internal receiver inputs the fourth stressed test signal.

28. A method comprising:
outputting a first reference test signal from a first output port of a communication testing device;
inputting a second reference test signal into a first input port of the communication testing device; and
outputting a first stressed test signal from a second output port of the communication testing device.
